(19) United States
(12) Patent Application Publication
(10) Pub. No.: US 2009/0204351 A1
(43) Pub. Date: Aug. 13, 2009

(54) Sensor Apparatus

(76) Inventor: Yasuhiro Tamura, Tokyo (JP)

Correspondence Address: Ralph A. Dowell of DOWELL & DOWELL P.C., 2111 Eisenhower Ave, Suite 406, Alexandria, VA, 22314, US

(21) Appl. No.: 11/990,489

(22) PCT Filed: Aug. 18, 2005
(86) PCT No.: PCT/JP2005/015098

§ 371 Date: Dec. 23, 2008

(51) Int. Cl. G01C 9/08; G01C 25/00; G06F 19/00

(52) U.S. Cl. 702/85; 702/154

(57) ABSTRACT

A sensor apparatus includes: a detection unit which includes a 3-axis acceleration sensor and a temperature sensor; and a processing unit which includes an acceleration vector calculating unit, a total acceleration calculating unit for calculating the magnitude of an acceleration vector, a tilt angle calculating unit for calculating tilt angles from the acceleration vector, and a temperature calculating unit. The tilt angle calculating unit discontinues the processing of calculating the tilt angles if the magnitude of the acceleration vector is different from that of gravitational acceleration.

### TECHNICAL FIELD

The present invention relates to a sensor apparatus, and in particular, to a sensor apparatus which includes an acceleration sensor.

### BACKGROUND TECHNOLOGY

Portable terminals that implement a magnetic sensor, such as cellular phones, have been put to practical use in recent years. Some of these portable terminals have the function of not only measuring azimuth directions but also displaying the current position and the like on a map on-screen according to the measured azimuth direction based on position information from GPS (Global Positioning System).

Azimuth angles available from magnetic sensors indicate the correct azimuth angles if the sensor planes of the magnetic sensors are horizontal, and with an error if the sensor planes are tilted. This error can be corrected by conducting coordinate transformation to a horizontal plane based on tilt angles (pitch angle, roll angle) acquired from an acceleration sensor, and determining the geomagnetic vector in the horizontal position (for example, see Patent Document 1).

### [Patent Document 1] Japanese Patent Application Laid-Open No. 2003-42766.

### DISCLOSURE OF THE INVENTION

### Problems to be Solved by the Invention

A 3-axis acceleration sensor can detect gravitational acceleration when at rest. When the acceleration sensor is moving with acceleration, however, it also detects acceleration components other than the gravitational acceleration. This creates the possibility that tilt angles calculated may contain errors when the acceleration sensor is moving. If the tilt angles contain errors, the azimuth angle that is corrected by the coordinate transformation based on those tilt angles will also incorporate an error.

The present invention has been achieved in view of the foregoing circumstances, and an objective thereof is to provide a sensor apparatus which can suitably measure tilt angles and an azimuth angle.

### Means for Solving the Problems

To solve the foregoing problem, a sensor apparatus according to one embodiment of the present invention includes: a 3-axis acceleration sensor; an acceleration vector calculating unit which calculates an acceleration vector from values detected by the acceleration sensor; a total acceleration calculating unit which calculates a magnitude of the acceleration vector; and a tilt angle calculating unit which calculates a tilt angle of the acceleration sensor based on the acceleration vector. The tilt angle calculating unit discontinues the processing of calculating the tilt angle if the magnitude of the acceleration vector is different from that of gravitational acceleration.

According to this embodiment, the processing of calculating the tilt angle is discontinued if the magnitude of the acceleration vector is different from that of gravitational acceleration. This can preclude a situation in which an incorrect tilt angle is derived from detection values from the acceleration sensor that contain acceleration components other than gravitational acceleration, thereby allowing suitable measurement of the tilt angle.

The sensor apparatus according to the foregoing embodiment may further include a temperature sensor. The acceleration vector calculating unit may calculate the acceleration vector with a correction based on temperature information detected by the temperature sensor.

The acceleration sensor varies in offset and sensitivity depending on temperature changes. The temperature correction can thus improve the precision with which the acceleration vector is measured. The improved precision of the acceleration vector can also improve the precision with which the tilt angle is measured.

The sensor apparatus according to the foregoing embodiment may further include: a 3-axis magnetic sensor which detects a geomagnetic vector; and an azimuth angle calculating unit which calculates an azimuth angle of the sensor apparatus through coordinate transformation of the geomagnetic vector detected by the magnetic sensor, using the tilt angle calculated by the tilt angle calculating unit. The azimuth angle calculating unit may discontinue the processing of calculating the azimuth angle if the magnitude of the acceleration vector is different from that of gravitational acceleration.

In this case, the processing of calculating the azimuth angle is discontinued if the magnitude of the acceleration vector is different from that of gravitational acceleration. This can preclude a situation in which an incorrect azimuth angle is derived from detection values from the acceleration sensor that contain acceleration components other than gravitational acceleration, thereby allowing suitable measurement of the azimuth angle.

It should be appreciated that arbitrary combinations of the foregoing constituting elements, and implementations of the invention in the form of methods, systems, recording media, computer programs, and the like are also applicable as embodiments of the present invention.

### EFFECTS OF THE INVENTION

According to the present invention, it is possible to provide a sensor apparatus which can suitably measure the tilt angles and azimuth angle.

### BRIEF DESCRIPTION OF THE DRAWINGS

FIG. 1 is a diagram showing the configuration of a sensor apparatus according to a first embodiment of the present invention;

FIG. 2 is a flowchart for the processing of calculating tilt angles;

FIG. 3 is a diagram showing the configuration of a sensor apparatus according to a second embodiment of the present invention;

FIG. 4 is a flowchart for the processing of calculating an azimuth angle.

### DESCRIPTION OF REFERENCE NUMERALS

10 sensor apparatus, 12 detection unit, 13 A/D conversion unit, 14 processing unit, 16 storage unit, 18 magnetic sensor, 20 acceleration sensor, 22 temperature sensor, 24 atmospheric pressure sensor, 26 geomagnetic vector calculating unit, 28 azimuth angle calculating unit, 30 acceleration vector calculating unit, 32 tilt angle calculating unit, 34 total acceleration calculating unit, 36 temperature calculating unit, 38 atmospheric pressure calculating unit, 40 altitude calculating unit, and 100 sensor apparatus.

### THE BEST MODE FOR CARRYING OUT THE INVENTION

### First Embodiment

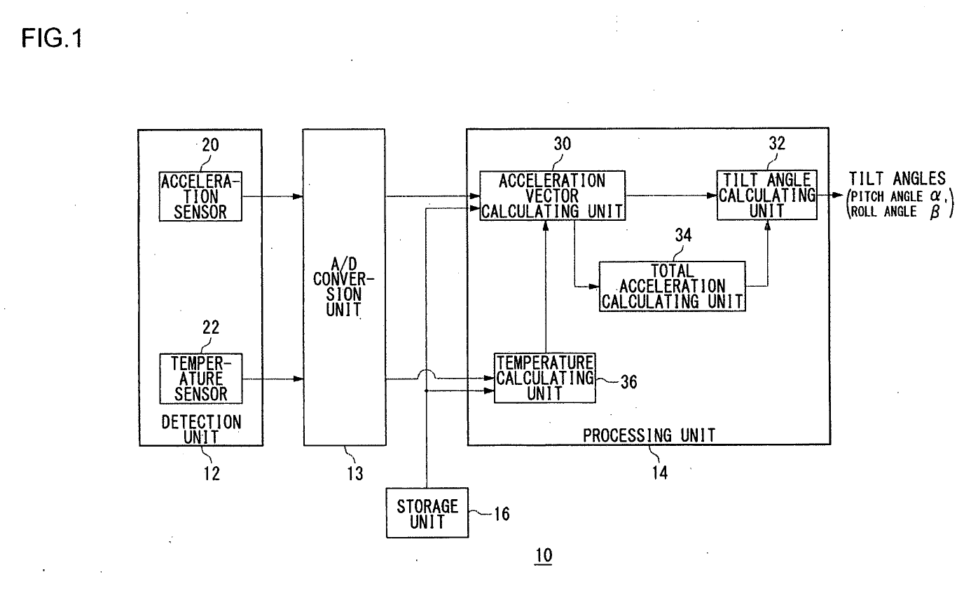

FIG. 1 is a diagram showing the configuration of a sensor apparatus 10 according to a first embodiment of the present invention. The sensor apparatus 10 includes a detection unit 12, an A/D conversion unit 13, a processing unit 14, and a storage unit 16. The detection unit 12 has an acceleration sensor 20 and a temperature sensor 22. The sensor apparatus 10 can measure and output tilt angles (pitch angle α, roll angle β) of the acceleration sensor 20.

The acceleration sensor 20 is a 3-axis acceleration sensor, and has the function of detecting an acceleration vector in mutually orthogonal X-, Y-, and Z-directions. The acceleration sensor 20 is not limited to any particular system, and may be any one of a resistance variation system, a capacitance variation system, a piezoelectric variation system, and the like.

The temperature sensor 22 detects the temperature inside the sensor apparatus 10. The detected temperature is used to correct deviations in the output of the acceleration sensor 20 due to temperature drifting. The analog values detected by the acceleration sensor 20 and the temperature sensor 22 are converted into respective digital values by the A/D conversion unit 13, and output to the processing unit 14.

The storage unit 16 contains characteristic data on the acceleration sensor 20 and the temperature sensor 22. The storage unit 16 may be a storage device such as EEPROM (Electrically Erasable Programmable Read Only Memory).

The processing unit 14 processes the signals that are output from the acceleration sensor 20 and the temperature sensor 22 and converted into digital values by the A/D conversion unit 13, and outputs the tilt angles (pitch angle α, roll angle β) of the acceleration sensor 20. The pitch angle α is a tilt angle in the X-direction. The roll angle β is a tilt angle in the Y-direction. The processing unit 14 includes an acceleration vector calculating unit 30, a tilt angle calculating unit 32, a total acceleration calculating unit 34, and a temperature calculating unit 36.

The temperature calculating unit 36 calculates the temperature t (in units of ° C.) inside the sensor apparatus 10 from an A/D-converted digital value Dt detected by the temperature sensor 22. The temperature t is calculated with equation (1), using the characteristic data on the temperature sensor 22 stored in the storage unit 16 (the digital value Dt0 of a reference temperature, the amount of change ΔDt per 1° C.). In equation (1), t0 is the reference temperature (° C.)

t=t0+(Dt−Dt0)/ΔDt (1)

The acceleration vector calculating unit 30 calculates the acceleration vector (xa,ya,za) (in units of G) from A/D-converted digital values (Dxa,Dya,Dza) in three axial components on the X-, Y-, and Z-axes, detected by the acceleration sensor 20. The acceleration vector (xa,ya,za) is calculated with equations (2) to (4), using the characteristic data on the acceleration sensor 20 stored in the storage unit 16 (digital offset values (Dxaoff,Dyaoff,Dzaoff) of the three axial components, and sensitivities (ΔDxa,ΔDya,ΔDza) to the gravitational acceleration (=1 G)):

xa=(Dxa−Dxaoff)/ΔDxa (2)

ya=(Dya−Dyaoff)/ΔDya (3)

za=(Dza−Dzaoff)/ΔDza (4)

Since the acceleration sensor 20 varies in offset and sensitivity depending on temperature, the acceleration vector is preferably calculated with a correction based on the temperature information detected by the temperature sensor 22. The temperature correction can be performed to improve the precision with which the acceleration vectors (xa,ya,za) are measured.

The total acceleration calculating unit 34 calculates the magnitude of the acceleration vector (xa,ya,za) which is calculated by the acceleration vector calculating unit 30. The magnitude of the acceleration vector (xa,ya,za) will be referred to as total acceleration a. The total acceleration a is calculated using equation (5):

a=\sqrt{xₐ²+yₐ²+zₐ²} (5)

When the acceleration sensor 20 is at rest, the total acceleration a is equal to 1 G. When the acceleration sensor 20 is moving with acceleration such as vibration, it has a value different from 1 G.

The tilt angle calculating unit 32 calculates the tilt angles (pitch angle α, roll angle β) of the acceleration sensor 20 based on the acceleration vector (xa,ya,za), which is calculated by the acceleration vector calculating unit 30. The formulas for calculating the pitch angle α and the roll angle β are expressed as equations (6) and (7):

α=arcsin (xa) (6)

β=arcsin (ya/cos α) (7)

The tilt angle calculating unit 32 determines whether or not the total acceleration a calculated by the total acceleration calculating unit 34 is equal to 1 G, and calculates the tilt angles only if the total acceleration a is equal to 1G. The tilt angle calculating unit 32 retains the value of the gravitational acceleration 1 G in advance, and compares the total acceleration a with 1 G. If the total acceleration a is different from 1 G, the processing of calculating the tilt angles is discontinued. The determination as to whether or not the total acceleration a is equal to 1 G is made with some margin. For example, the total acceleration a is determined to be equal to 1 G if the total acceleration a falls within the range of 0.9 G≦a≦1.1 G.

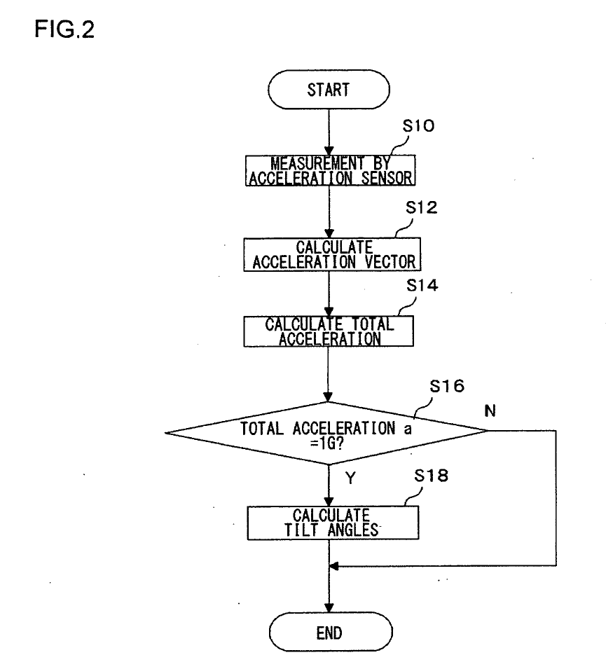

FIG. 2 is a flowchart for the processing of calculating tilt angles. Initially, the acceleration sensor 20 measures acceleration to acquire the digital values (Dxa,Dya,Dza) of the acceleration vector (S10). Next, the acceleration vector calculating unit 30 calculates the acceleration vector (xa,ya,za) (S12). Next, the total acceleration calculating unit 34 calculates the total acceleration a from the acceleration vector (xa,ya,za) (S14).

Next, the tilt angle calculating unit 32 determines whether or not the total acceleration a is equal to 1 G (S16). If the acceleration vector measured by the acceleration sensor 20 contains any acceleration component other than gravitational acceleration, the total acceleration a has a value different from 1 G. Whether or not the total acceleration a is equal to 1 G can thus be determined to judge if any acceleration component other than the gravitational acceleration is included.

If the total acceleration a is equal to 1 G (Y at S16), the tilt angle calculating unit 32 performs the processing of calculating the tilt angles (S18). If the total acceleration a is different from 1 G (N at S16), the tilt angle calculating unit 32 discontinues the processing of calculating the tilt angles, without calculating the tilt angles.

If the processing of calculating the tilt angles is performed without the comparison between the total acceleration a and gravitational acceleration, the tilt angles calculated may possibly contain errors. According to the sensor apparatus 10 of the first embodiment, it is possible to preclude a situation in which incorrect tilt angles are derived based on detection values from the accelerating sensor 20 that contain acceleration components other than gravitational acceleration.

### Second Embodiment

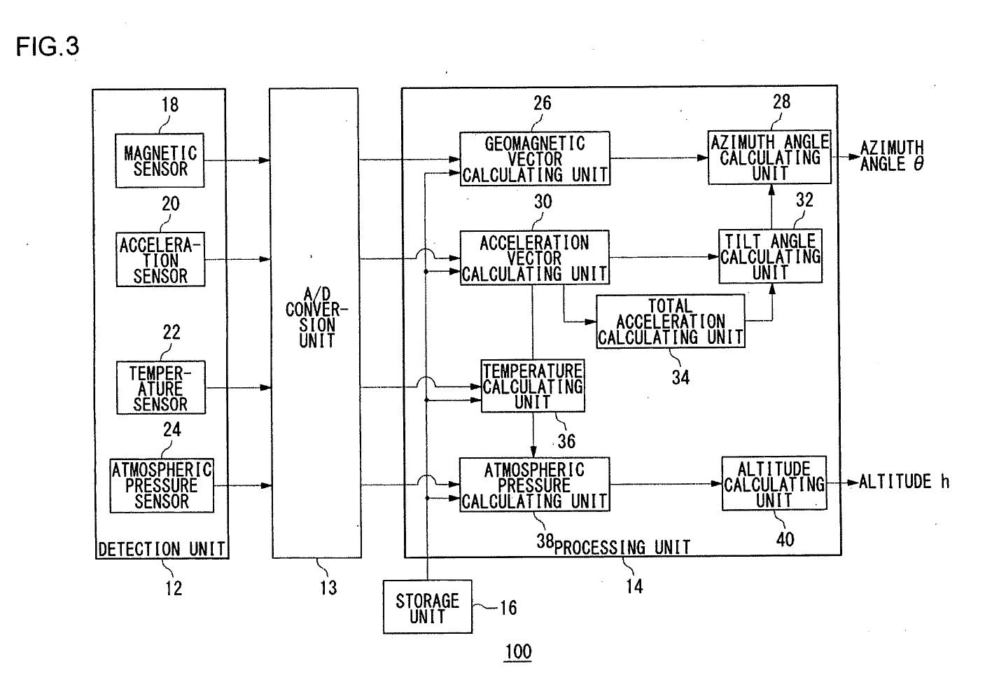

FIG. 3 is a diagram showing the configuration of a sensor apparatus 100 according to a second embodiment of the present invention. The sensor apparatus 100 can output an azimuth angle θ and an altitude h. In the second embodiment, the detection unit 12 further includes a magnetic sensor 18 and an atmospheric pressure sensor 24. Moreover, the processing unit 14 further includes a geomagnetic vector calculating unit 26, an azimuth angle calculating unit 28, an atmospheric pressure calculating unit 38, and an altitude calculating unit 40. It should be appreciated that the same components as in the first embodiment will be described with identical reference numerals.

The atmospheric pressure sensor 24 detects the pressure of the outside air. The atmospheric pressure calculating unit 38 calculates the atmospheric pressure p (in units of hPa) from an A/D-converted digital value Dp detected by the atmospheric pressure sensor 24. The atmospheric pressure p is calculated with equation (8), using characteristic data on the atmospheric pressure sensor 24 stored in the storage unit 16 (digital offset value Dpoff, sensitivity ΔDp per 1 hPa):

p=(Dp−Dpoff)/ΔDp+1013.25 (8)

Since the atmospheric pressure sensor 24 varies in offset and sensitivity depending on temperature, the atmospheric pressure p is preferably corrected on the basis of the temperature information detected by the temperature sensor 22. The temperature correction can be performed to improve the precision with which the atmospheric pressure p is measured.

The altitude calculating unit 40 calculates a relative altitude h (in units of m) from a difference between the atmospheric pressure p calculated by the atmospheric pressure calculating unit 38 and a reference atmospheric pressure p0. The relative altitude refers to an altitude calculated with the reference atmospheric pressure being taken as being at 0 m. Since the atmospheric pressure decreases by 12 hPa with every 100 m increase in altitude, it can be calculated using equation (9):

h=(p0−p)×100/12 (9)

The magnetic sensor 18 is a 3-axis magnetic sensor, and has the function of detecting geomagnetic vector components in the mutually orthogonal X-, Y-, and Z-directions. The magnetic sensor 18 may be formed by combining flux-gate magnetic sensors, Hall elements, magnetoresistive elements, etc.

The geomagnetic vector calculating unit 26 calculates the geomagnetic vector (x,y,z) (in units of T) from A/D-converted digital values (Dx,Dy,Dz) detected by the magnetic sensor 18. The geomagnetic vector (x,y,z) is calculated with equations (10) to (12), using characteristic data on the magnetic sensor 18 stored in the storage unit 16 (digital offset values (Dxoff,Dyoff,Dzoff) of the three axial components, and sensitivities (ΔDx,ΔDy,ΔDz) per 1 μT):

x=(Dx−Dxoff)/ΔDx (10)

y=(Dy−Dyoff)/ΔDy (11)

z=(Dz−Dzoff)/ΔDz (12)

The azimuth angle calculating unit 28 calculates the azimuth angle θ of the magnetic sensor 18 through coordinate transformation of the geomagnetic vector (x,y,z) calculated by the geomagnetic vector calculating unit 26, using the tilt angles (pitch angle α, roll angle β) calculated by the tilt angle calculating unit 32.

The azimuth angle θ is calculated from the X-axis component x and the Y-axis component y of the geomagnetic vector (x,y,z), though this will incorporate an error if the magnetic sensor 18 is tilted. Thus, the geometric vector in a horizontal position is determined through coordinate transformation to a horizontal plane. The coordinate transformation formula can be expressed as equation (13):

$$[ \begin{matrix}hx & hy & hz\end{matrix} ] = [ \begin{matrix}x & y & z\end{matrix} ] [ \begin{matrix}cos β & 0 & - sin β \\ 0 & 1 & 0 \\ sin β & 0 & cos β\end{matrix} ] [ \begin{matrix}1 & 0 & 0 \\ 0 & cos α & sin α \\ 0 & - sin α & cos α\end{matrix} ] \qquad ( 13 )$$

where α is the pitch angle, β is the roll angle, (x,y,z) is the geomagnetic vector before transformation, and (hx,hy,hz) is the geomagnetic vector after the coordinate transformation.

Using the X-axis component hx and the Y-axis component hy of the coordinate-transformed geomagnetic vector, the azimuth angle θ is calculated equation (14):

θ=arctan (hx/hy) (14)

The acceleration vector calculating unit 30 calculates the acceleration vector from the values detected by the acceleration sensor 20. The total acceleration calculating unit 34 calculates the total acceleration a. The tilt angle calculating unit 32 determines whether or not the total acceleration a calculated by the total acceleration calculating unit 34 is equal to 1 G, and calculates the tilt angles only if the total acceleration a is equal to 1 G. If the total acceleration a is different from 1 G, the processing of calculating the tilt angles is discontinued. If the tilt angles are calculated, the values of the tilt angles are supplied to the azimuth angle calculating unit 28. If the processing of calculating the tilt angles is discontinued, an instruction to discontinue the processing of calculating the azimuth angle is given to the azimuth angle calculating unit 28.

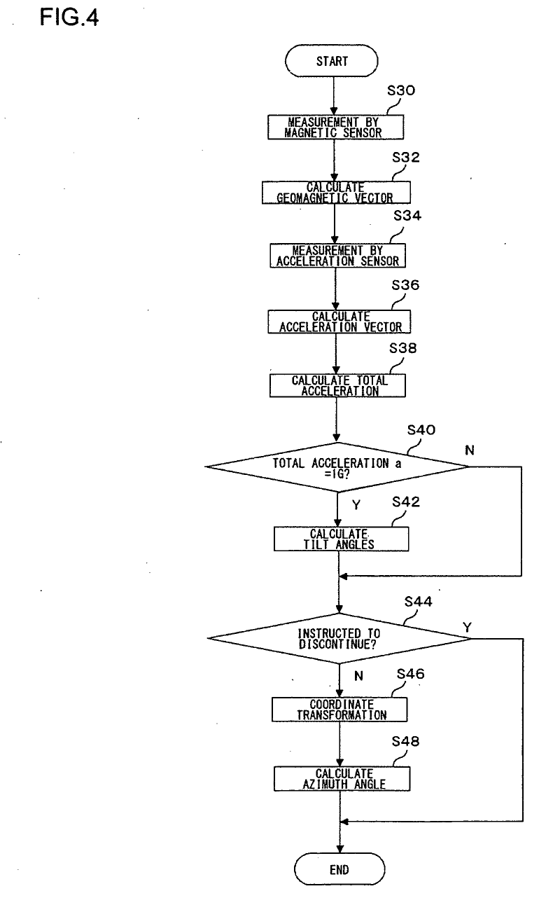

FIG. 4 is a flowchart for the processing of calculating an azimuth angle. Initially, the magnetic sensor 18 measures geomagnetism to acquire the digital values (Dx,Dy,Dz) of the geomagnetic vector (S30). Next, the geomagnetic vector calculating unit 26 calculates the geomagnetic vector (x,y,z) (S32).

The acceleration sensor 20 measures acceleration to acquire the digital values (Dxa,Dya,Dza) of the acceleration vector (S34). Next, the acceleration vector calculating unit 30 calculates the acceleration vector (xa,ya,za) (S36). Next, the total acceleration calculating unit 34 calculates the total acceleration a from the acceleration vector (xa,ya,za) (S38).

Next, the tilt angle calculating unit 32 determines whether or not the total acceleration a is equal to 1 G (S40). If the total acceleration a is equal to 1 G (Y at S40), the tilt angle calculating unit 32 performs the processing of calculating the tilt angles, and supplies the values of the tilt angles to the azimuth angle calculating unit 28 (S42). If the total acceleration a is different from 1 G (N at S40), the tilt angle calculating unit 32 discontinues the processing of calculating the tilt angles without calculating the tilt angles. If the process of calculating the tilt angles is discontinued, the tilt angle calculating unit 32 gives an instruction to discontinue the processing of calculating the azimuth angle to the azimuth angle calculating unit 28. It should be appreciated that the processing of calculating the geomagnetic vector (S30 to S32) and the processing of calculating the tilt angles (S34 to 42) may be in reverse order, or may be performed at the same time.

If no instruction is given by the tilt angle calculating unit 32 to discontinue the processing of calculating the azimuth angle (N at S44), the azimuth angle calculating unit 28 performs coordinate transformation on the geomagnetic vector (x,y,z) to calculate the coordinate-transformed geomagnetic vector (hx,hy,hz) (S46). Subsequently, the azimuth angle θ is calculated using the X-axis component hx and the Y-axis component hy of the coordinate-transformed geomagnetic vector (S48). If the instruction to discontinue the processing of calculating the azimuth angle is issued from the tilt angle calculating unit 32, on the other hand, the azimuth angle calculating unit 28 discontinues the processing of calculating the azimuth angle (Y at S44).

As mentioned above, in situations where the acceleration sensor 20 is moving with acceleration, the detection values of the acceleration sensor 20 contain acceleration components other than gravitational acceleration. In this case, the tilt angles calculated will contain an error. Coordinate transformation using these erroneous tilt angles, in turn, yields an azimuth angle θ that also has an error. In the sensor apparatus 100 according to the second embodiment, the processing of calculating the azimuth angle θ is discontinued if the total acceleration a is different from 1 G. This makes it possible to preclude a situation in which an incorrect azimuth angle θ is derived based on detection values from the accelerating sensor 20 that contain acceleration components other than gravitational acceleration.

Up to this point, the present invention has been described in conjunction with the embodiments thereof. The embodiments have been given solely by way of illustration. It will be understood by those skilled in the art that various modifications may be made to combinations of the foregoing constituting elements and processes, and all such modifications are also intended to fall within the scope of the present invention.

For example, in the second embodiment, the comparison between the total acceleration a and 1 G is made by the tilt angle calculating unit 32. Nevertheless, the total acceleration calculating unit 34 may supply the value of the total acceleration a to the azimuth angle calculating unit 28 so that the azimuth angle calculating unit 28 compares the total acceleration a with 1 G to determine whether or not to discontinue the processing of calculating the azimuth angle.

### INDUSTRIAL APPLICABILITY

The preset invention is applicable to fields pertaining to sensor apparatuses that have an acceleration sensor.

1. A sensor apparatus comprising:
a 3-axis acceleration sensor;
an acceleration vector calculating unit which calculates an acceleration vector from values detected by the acceleration sensor;
a total acceleration calculating unit which calculates a magnitude of the acceleration vector; and
a tilt angle calculating-unit which calculates a tilt angle of the acceleration sensor based on the acceleration vector, wherein
the tilt angle calculating unit discontinues the processing of calculating the tilt angle if the magnitude of the acceleration vector is different from that of gravitational acceleration.

2. A sensor apparatus according to claim 1, further comprising a temperature sensor, and wherein
the acceleration vector calculating unit calculates the acceleration vector with a correction based on temperature information detected by the temperature sensor.

3. A sensor apparatus according to claim 1, further comprising:
a 3-axis magnetic sensor which detects a geomagnetic vector; and
an azimuth angle calculating unit which calculates an azimuth angle of the sensor apparatus through coordinate transformation of the geomagnetic vector detected by the magnetic sensor, using the tilt angle calculated by the tilt angle calculating unit, and wherein
the azimuth angle calculating unit discontinues the processing of calculating the azimuth angle if the magnitude of the acceleration vector is different from that of gravitational acceleration.

4. A sensor apparatus according to claim 2, further comprising:
a 3-axis magnetic sensor which detects a geomagnetic vector; and
an azimuth angle calculating unit which calculates an azimuth angle of the sensor apparatus through coordinate transformation of the geomagnetic vector detected by the magnetic sensor, using the tilt angle calculated by the tilt angle calculating unit, and wherein
the azimuth angle calculating unit discontinues the processing of calculating the azimuth angle if the magnitude of the acceleration vector is different from that of gravitational acceleration.
